(19) United States
(12) Patent Application Publication
(10) Pub. No.: US 2026/0302529 A1
(43) Pub. Date: Oct. 1, 2026

(54) SECONDARY BATTERY AND ELECTRONIC DEVICE INCLUDING SECONDARY BATTERY

(71) Applicant: SAMSUNG SDI CO., LTD., Yongin-si (KR)

(72) Inventors: Soo-Mi EO, Yongin-si (KR); Jeawoan LEE, Yongin-si (KR)

(21) Appl. No.: 19/563,488

(22) Filed: Mar. 11, 2026

(30) Foreign Application Priority Data
Mar. 28, 2025 (KR) 10-2025-0040542

(51) Int. Cl. H01M 50/30; H01M 50/103; H01M 50/119; H01M 50/15

(52) U.S. Cl. CPC H01M 50/394; H01M 50/103; H01M 50/119; H01M 50/15

(57) ABSTRACT

A secondary battery according to some embodiments of the present disclosure may include an electrode assembly including a first electrode, a second electrode, and a separator and a case accommodating the electrode assembly. The case may include a body part having an open side and accommodating the electrode assembly and a cover plate covering the open side of the body part and including a vent portion.

### CROSS-REFERENCE TO RELATED APPLICATIONS

This present application claims priority to and the benefit under 35 U.S.C. § 119(a)-(d) of Korean Patent Application No. 10-2025-0040542, filed on Mar. 28, 2025, in the Korean Intellectual Property Office, the entire disclosure of which is incorporated herein by reference.

### BACKGROUND

### Field

Aspects of embodiments of the present disclosure relate to a secondary battery and an electronic device including a secondary battery.

### Description of Related Art

A secondary battery is a battery that may be charged and discharged, unlike a primary battery which is not rechargeable. A low-capacity secondary battery is used in portable small electronic devices such as smartphones, feature phones, laptop computers, digital cameras, and camcorders, while a high-capacity secondary battery is widely used as a power source for driving motors or as a power storage battery, for example, in hybrid or electric vehicles. Such a secondary battery includes an electrode assembly including a cathode and an anode, a case housing the electrode assembly, and an electrode terminal connected to the electrode assembly.

A conventional pouch-type secondary battery includes a case made of a material in which a metal film is thinly laminated between polymer layers. After the pouch-type secondary battery is mounted in an electronic device, a problem of deformation of the case may occur due to flexibility of the polymer layer during replacement or removal of the secondary battery. The present disclosure seeks to solve such a problem.

The above information disclosed in this Background section is for enhancement of understanding of the background of the present disclosure, and therefore, it may contain information that does not constitute related (or prior) art.

### SUMMARY

Embodiments of the present disclosure provide a secondary battery and an electronic device with the same.

These and other aspects and features of the present disclosure will be described in or will be apparent from the following description of embodiments of the present disclosure.

A secondary battery according to some embodiments of the present disclosure may include an electrode assembly including a first electrode, a second electrode, and a separator and a case accommodating the electrode assembly. The case may include a body part having an open side and accommodating the electrode assembly and a cover plate covering the open side of the body part and including a vent portion.

In some embodiments, the vent portion may be at a corner portion of the cover plate.

In some embodiments, the cover plate may include a first edge, a second edge spaced apart from the first edge in a first direction, a third edge spaced apart from the second edge in a second direction perpendicular to the first direction, and a fourth edge spaced apart from the first edge in the second direction. The corner portion may be a rectangular region formed by sides of the cover plate at a 1/4 point on a diagonal line extending from the first edge to the third edge.

In some embodiments, a depth of the vent portion may be from about 30% to about 80% of a thickness of the cover plate.

In some embodiments, the depth of the vent portion varies depending on a location of the vent portion in the cover plate.

In some embodiments, the vent portion may be in an outer surface of the cover plate.

In some embodiments, the vent portion may be in an inner surface of the cover plate.

In some embodiments, the vent portion may be a first vent portion. The cover plate may further include a second vent portion.

In some embodiments, the first vent portion may be in an inner surface of the cover plate. The second vent portion may be in an outer surface of the cover plate.

In some embodiments, a depth of the first vent portion may be equal to a depth of the second vent portion.

In some embodiments, a depth of the first vent portion may be different from a depth of the second vent portion.

In some embodiments, a geometry of the vent portion may be a curved line, a single straight line, a plurality of intersecting straight lines, or a circular geometry.

In some embodiments, a material of the case may include stainless steel.

In some embodiments, the secondary battery may further include a flange portion. The cover plate and the flange portion may be joined together to seal the case.

An electronic device according to some embodiments of the present disclosure may include an operator configured to perform a predetermined operation, a secondary battery supplying power to the operator, and a housing accommodating the operator and the secondary battery and fixing a position of the operator and a position of the secondary battery. The secondary battery may include an electrode assembly including a first electrode, a second electrode, and a separator and a case accommodating the electrode assembly. The case may include a body part having an open side and accommodating the electrode assembly and a cover plate covering the open side of the body part and including a vent portion.

A method of forming a vent portion in the case of electronic device may include etching the vent portion into the cover plate.

In some embodiments, the vent portion may be at a corner portion of the cover plate.

In some embodiments, the vent portion may be in an inner surface or in an outer surface of the cover plate.

In some embodiments, the vent portion may be a first vent portion. The cover plate may further include a second vent portion.

In some embodiments, the first vent portion may be in an inner surface of the cover plate. The second vent portion may be in an outer surface of the cover plate.

The technical problem to be solved by the present disclosure is not limited to the above embodiments. Further, other technical problems not mentioned herein may be solved, and some aspects and some features of the present disclosure may address said other technical problems as well, as will be clearly understood by those skilled in the art from the description, drawings, and claims of the present disclosure.

According to some embodiments of the present disclosure, the cover plate includes a vent portion, and the vent portion may rupture when internal pressure increases and may thereby discharge internal gas to outside of the case.

According to some embodiments of the present disclosure, a vent portion is formed at a corner portion of the cover plate where deformation is severe so that rupture of the vent portion may more easily occur when internal pressure increases.

However, aspects and features of the present disclosure are not limited to those described above, and other aspects and features not mentioned will be clearly understood by a person skilled in the art from the detailed description, described below.

### BRIEF DESCRIPTION OF DRAWINGS

The following drawings attached to the present specification illustrate embodiments of the present disclosure, and further describe aspects and features of the present disclosure together with the detailed description of the present disclosure. Thus, the present disclosure should not be construed as being limited to the drawings:

FIG. 1 is a perspective view illustrating a secondary battery according to some embodiments of the present disclosure.

FIG. 2 is an exploded perspective view illustrating a secondary battery according to some embodiments of the present disclosure.

FIG. 3 is a diagram illustrating a vent portion formed in a cover plate according to some embodiments of the present disclosure.

FIG. 4 is a diagram illustrating a vent portion formed in a cover plate according to some embodiments of the present disclosure.

FIG. 5 is a diagram illustrating a position of a vent portion formed in a cover plate according to some embodiments of the present disclosure.

FIG. 6 is a cross-sectional view of a vent portion according to some embodiments of the present disclosure.

FIG. 7 is a cross-sectional view of a vent portion according to some embodiments of the present disclosure.

FIG. 8 is a cross-sectional view of a vent portion according to some embodiments of the present disclosure.

FIG. 9 is a diagram illustrating various geometries of a vent portion according to some embodiments of the present disclosure.

FIG. 10 is a diagram illustrating various geometries of a vent portion according to some embodiments of the present disclosure.

FIG. 11 is a diagram illustrating various geometries of a vent portion according to some embodiments of the present disclosure.

FIG. 12 is a diagram illustrating various geometries of a vent portion according to some embodiments of the present disclosure.

FIG. 13 is a diagram illustrating an electronic device including a secondary battery according to some embodiments of the present disclosure.

FIG. 14 is a diagram illustrating an electronic device including a secondary battery according to some embodiments of the present disclosure.

### DETAILED DESCRIPTION

Hereinafter, embodiments of the present disclosure will be described, in detail, with reference to the accompanying drawings. The terms or words used in the present specification and claims are not to be limitedly interpreted as general or dictionary meanings and should be interpreted as meanings and concepts that are consistent with the technical idea of the present disclosure on the basis of the principle that an inventor can be his/her own lexicographer to appropriately define concepts of terms to describe his/her invention in the best way.

The embodiments described in this specification and the configurations shown in the drawings are only some of the embodiments of the present disclosure and do not represent all of the technical spirit, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements and/or layers may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” and “upper,” may be used herein for ease of description to describe one element or feature’s relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value greater than or equal to 1.0 and a maximum value less than or equal to 10.0, such as, for example, 2.4 to 7.6. Any maximum numerical limitation recited herein is intended to include all lesser numerical limitations subsumed therein, and any minimum numerical limitation recited in this specification is intended to include all greater numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements and/or features as being “the same” may mean that they are “substantially the same.” Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components.”

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

The terms used in the present specification are for describing embodiments of the present disclosure and are not intended to limit the present disclosure.

In the present disclosure, sizes and relative sizes of layers and regions shown in the drawings may be exaggerated for clarity of explanation. The sizes shown in the drawings are for convenience of understanding and are not limited thereto. Also, throughout the specification, the same reference numerals may refer to the same components.

In a secondary battery using a case using a metal material including stainless steel (SUS), when an abnormal event occurs (for example, overcharging, prolonged exposure to high temperature, and/or generation of heat due to an internal short circuit in the cell), gas may be generated inside the case of the secondary battery. Therefore, there is a risk that the secondary battery may explode, and a vent for discharging the gas may remedy the risk.

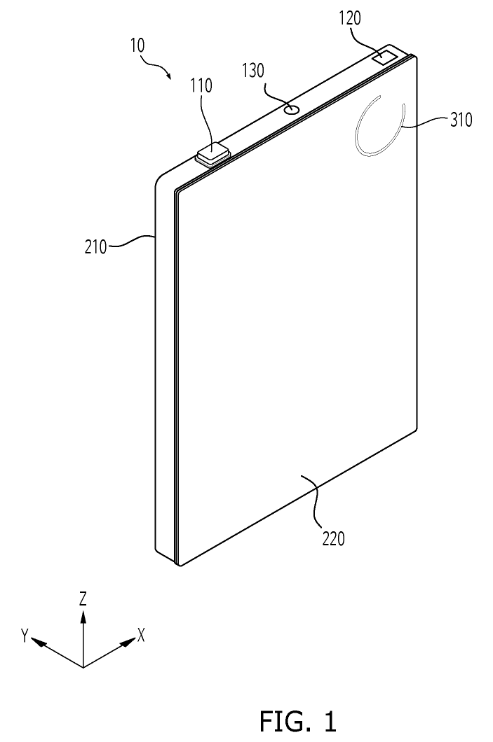

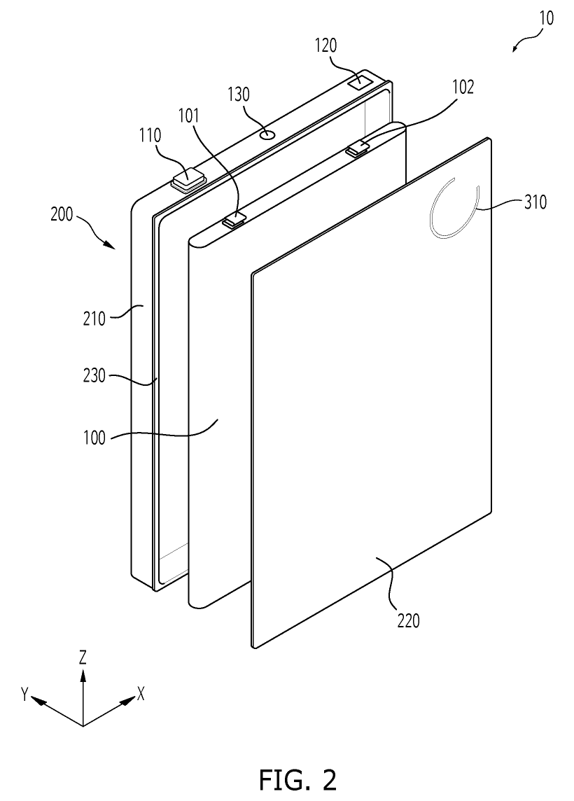

FIG. 1 is a perspective view illustrating a secondary battery according to some embodiments of the present disclosure. FIG. 2 is an exploded perspective view illustrating a secondary battery according to some embodiments of the present disclosure.

A secondary battery 10 according to some embodiments of the present disclosure may include an electrode assembly 100 and a case 200.

The electrode assembly 100 may include a first electrode, a second electrode, and a separator. The first electrode may be a cathode, and the second electrode may be an anode. In some embodiments, the electrode assembly 100 may be a wound-type electrode assembly formed by winding the separator, which is an insulator, between the first electrode and the second electrode. In some embodiments, the electrode assembly 100 may be a stacked-type electrode assembly in which the first electrode and the second electrode are alternately stacked with the separator interposed between the first electrode and the second electrode, or the electrode assembly 100 may be any structure including the first electrode and the second electrode. The above-described structure of the electrode assembly 100 is merely illustrative and the present disclosure is not limited thereto.

The first electrode may include a coated portion (in which an active material is coated on both surfaces of a first substrate formed of a thin metal plate) and a non-coated portion (in which the active material is not coated and the substrate is exposed). The first electrode may include a non-coated portion formed on both sides of the first substrate in a winding direction. The first electrode may be formed by coating a positive electrode active material, such as a transition metal oxide, on a metal substrate, such as aluminum or aluminum alloy, to form a positive electrode.

The second electrode may include a coated portion in which an active material is coated on both surfaces of a second substrate formed of a thin metal plate and may include a non-coated portion (in which the active material is not coated and the substrate is exposed). The second electrode may include a non-coated portion formed on both sides of the second substrate in a winding direction. The second electrode may be formed by coating a negative electrode active material, such as graphite or carbon, on a metal substrate, such as copper, copper alloy, nickel, or nickel alloy, to form a negative electrode.

The separator may be positioned between the first electrode and the second electrode. The separator may insulate the first electrode and the second electrode and may allow lithium ions to be exchanged between the first electrode and the second electrode. The separator may have a sufficient length to completely insulate the first electrode from the second electrode even if the electrode assembly 100 contracts or expands during charging or discharging of the secondary battery 10.

The electrode assembly 100 may further include a first electrode tab 101 and a second electrode tab 102. The first electrode tab 101 may be separately formed and connected to the non-coated portion of the first electrode or may be formed by punching out a part of the non-coated portion. The first electrode tab 101 may extend from the non-coated portion and may contact the first electrode terminal 110. The first electrode tab 101 may serve as a current flow path between the first electrode and the first electrode terminal 110. The second electrode tab 102 may be separately formed and connected to the non-coated portion of the second electrode or may be formed by punching out a part of the non-coated portion. The second electrode tab 102 may extend from the non-coated portion and may contact the case 200. The second electrode tab 102 may be in direct contact with the case 200 or may contact a negative electrode terminal provided on an inner side of the case 200. In some embodiments, the negative electrode terminal may be provided on an outer side of the case 200. The second electrode tab 102 may serve as a current flow path between the second electrode and the case 200.

The case 200 may form an overall external appearance of the secondary battery 10. The case 200 may be formed of stainless steel (SUS). The case 200 may be formed of a conductive metal such as aluminum, aluminum alloy, or nickel-plated steel. In one embodiment, a thickness of the case 200 may be from about 0.05 mm to about 0.5 mm, but the thickness of the case is not limited thereto.

The case 200 may include a body part 210 having an open side and accommodating the electrode assembly 100, a cover plate 220 covering an open side of the body part 210 and sealing the electrode assembly 100, and a flange portion 230 extending from the body part 210 and contacting the cover.

The body part 210 may accommodate the electrode assembly 100 in an internal space formed with one side open and having a step with the flange portion 230. The body part 210 may have an internal space having a dimension greater than that of the electrode assembly 100 and may accommodate the electrode assembly 100 and an electrolyte.

The cover plate 220 may be configured to cover one open side of the body part 210 and may seal the electrode assembly 100. When the electrode assembly 100 is accommodated in the body part 210, the cover plate 220 may cover the open side of the body part 210 and may be bonded to the flange portion 230. The cover plate 220 may be bonded to the flange portion 230 by welding.

The flange portion 230 may extend from the body part 210 and may contact the cover plate 220. The flange portion 230 may be provided along the edge of the body part 210. When the electrode assembly 100 is accommodated, the flange portion 230 provided at the edge of the body part 210 may contact the cover plate 220 and may be welded to the cover plate 220.

Although a structure having a flange portion is illustrated, the present disclosure is not limited thereto, and the body part 210 may be joined to the cover plate 220 without including a flange portion.

The cover plate 220 may include a vent portion 310 that opens a part of the electrode assembly 100. When an abnormal event occurs, pressure inside the secondary battery 10 may increase. When internal pressure of the secondary battery 10 increases beyond a predetermined pressure, the vent portion 310 may rupture, and gas inside the secondary battery 10 may be discharged through the vent portion 310. The gas being discharged through the vent portion 310 may prevent the secondary battery 10 from exploding. In FIG. 1, the vent portion 310 is illustrated as being formed in the cover plate 220, but the present disclosure is not limited thereto. According to some embodiments, the vent portion 310 may also be formed in the body part 210.

A first electrode terminal 110, a second electrode terminal 120, and an electrolyte injection hole 130 may be disposed on a side surface of the case 200. However, according to design conditions, side surfaces on which the first electrode terminal 110, the second electrode terminal 120, and the electrolyte injection hole 130 are disposed may be different.

The first electrode terminal 110 may be formed to penetrate one side surface of the case 200. An insulating gasket (not shown) may be interposed between the first electrode terminal 110 and the case 200, and the first electrode terminal 110 may be insulated from the case 200 through the insulating gasket. The first electrode terminal 110 may be electrically connected to the first electrode of the electrode assembly 100. The first electrode terminal 110 may be electrically connected to the first electrode through the first electrode tab 101. The first electrode terminal 110 may be electrically connected to the first electrode to function as a positive electrode.

The second electrode terminal 120 may be on one side surface of the case 200. The second electrode terminal 120 may be spaced apart from the first electrode terminal 110. The second electrode terminal 120 may be electrically connected to the case 200. The second electrode terminal 120 may be in contact with the case 200. Because the case 200 may be damaged during welding, the second electrode terminal 120 having high weld strength may be attached to the case 200. The second electrode terminal 120 may be formed of a metal thin film having excellent weld strength and greater electrical conductivity than the case 200.

The second electrode terminal 120 may be electrically connected to the second electrode of the electrode assembly 100. The case 200 may be electrically connected to the second electrode through the second electrode tab 102. The second electrode terminal 120 may be electrically connected to the second electrode through the case and the second electrode tab 102. The case 200 and the second electrode terminal 120 may be electrically connected to the second electrode and may function as a negative electrode.

The electrolyte injection hole 130 may be formed in one side surface of the case 200. The electrolyte injection hole 130 may be formed between the first electrode terminal 110 and the second electrode terminal 120, but the electrolyte injection hole 130 is not limited thereto and may be formed in any region on one side surface or another side surface. After the electrolyte is injected, the electrolyte injection hole 130 may be sealed by a sealer.

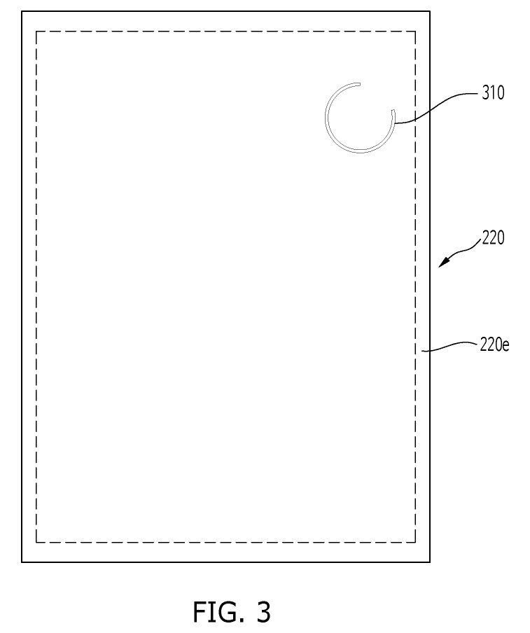

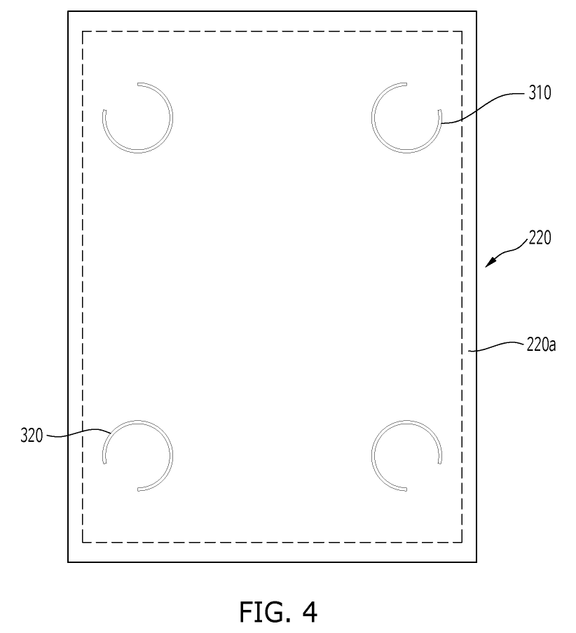

FIG. 3 is a diagram illustrating a vent portion formed in a cover plate according to some embodiments of the present disclosure. FIG. 4 is a diagram illustrating a vent portion formed in a cover plate according to some embodiments of the present disclosure.

Referring to FIG. 3, a vent portion 310 may be formed in the cover plate 220 of the case. The vent portion 310 may be a structure for releasing gas inside the case of the secondary battery in order to prevent explosion of the secondary battery. The vent portion 310 may rupture if the pressure inside the case of the secondary battery increases. The vent portion 310 may be formed in a region of the cover plate 220 facing the electrode assembly 100 (see FIG. 2). A region 220e along a periphery of the cover plate 220 may be welded to the flange portion 230 (see FIG. 2). The vent portion 310 may be formed inward from the region 220e of the cover plate 220 that contacts the flange portion 230. The vent portion 310 may be formed by etching.

Referring to FIG. 4, a plurality of vent portions 310 and 320 may be formed in a region adjacent to an edge of the cover plate 220. The vent portions 310 and 320 may include a first vent portion 310 and a second vent portion 320. At least one of vent portion 310 or 320 may be formed between a central region of the cover plate 220 and each corner of the cover plate 220, but the present disclosure is not limited thereto.

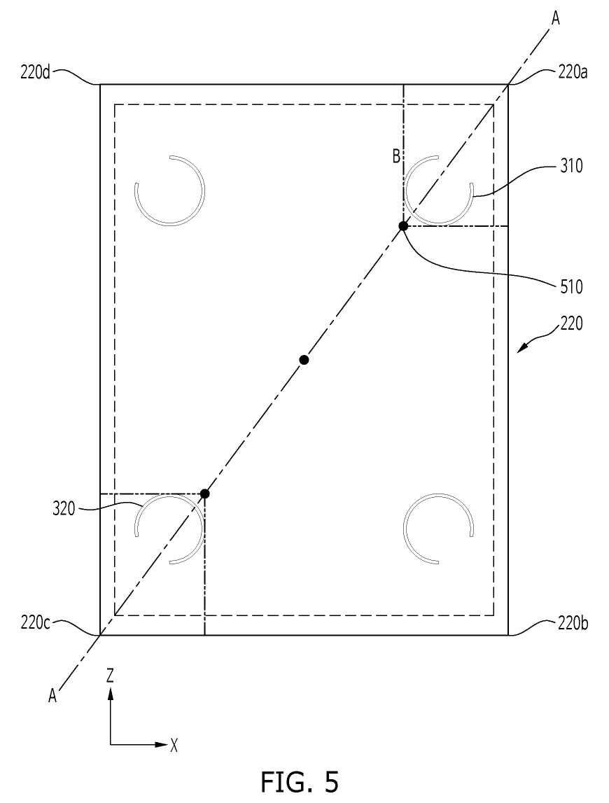

FIG. 5 is a diagram illustrating a position of a vent portion formed in a cover plate according to some embodiments of the present disclosure.

The cover plate 220 may be formed in a rectangular geometry. The cover plate 220 may include four edges. The cover plate 220 may include a first edge 220a, a second edge 220b spaced apart from the first edge 220a in a first direction (Y-axis), a third edge 220c spaced apart from the second edge 220b in a second direction (X-axis) perpendicular to the first direction, and a fourth edge 220d spaced apart from the first edge 220a in the second direction (X-axis).

The first vent portion 310 may be located at a corner portion B of the cover plate.

The corner portion B may be within a rectangular region formed by sides of the cover plate 220 (i.e., a side connecting 220a-220d and a side connecting 220a-220b) at a 1/4 point 510 on a diagonal line A-A extending from the first edge 220a to the third edge 220c. The second vent portion 320 may be similarly formed as described above.

The corner portion B may be within a rectangular region formed by the sides of the cover plate 220 (i.e., a side connecting 220a-220d and a side connecting 220a-220b) at a 1/2 point on the diagonal line A-A extending from the first edge 220a to the third edge 220c.

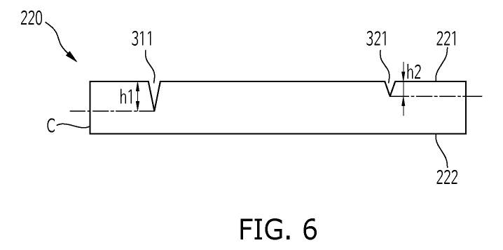

FIGS. 6-8 are cross-sectional views of a vent portion according to some embodiments of the present disclosure. Particularly, FIGS. 6-8 are views showing the cover plate of FIG. 5 cut along the A-A line.

A depth of the vent portion may be from about 30% to about 80% of a thickness of the cover plate. The vent portion may be formed as at least one vent portion in the cover plate. The depth of the vent portion may vary depending on a location of the vent portion. The vent portion may be formed in an outer surface and/or an inner surface of the cover plate.

According to a method of forming the vent portion into a case of a secondary battery, the vent portion may be formed by etching the vent portion into a cover plate.

Referring to FIG. 6, the vent portions 311 and 321 may include a first vent portion 311 and a second vent portion 321. The first vent portion 311 and the second vent portion 321 may be formed in an outer surface 221 of the cover plate 220 that is exposed to the outside. The depths of the first vent portion 311 and the second vent portion 321 may be different. A depth h1 of the first vent portion 311 may be greater than a depth h2 of the second vent portion 321. In some embodiments, the depth h1 of the first vent portion 311 and the depth h2 of the second vent portion 321 may be the same.

The depth h1 of the first vent portion 311 may vary. In some embodiments, the first vent portion 311, which may be closer to a corner of the cover plate, may be formed deeply, and the second vent portion 321, which may be farther from the corner of the cover plate, may be formed shallower than the first vent portion 311. In some embodiments, the first vent portion 311, which is closer to the corner of the cover plate, may be formed shallowly, and the second vent portion 321, which is farther from the corner of the cover plate, may be formed deeper than the first vent portion 311.

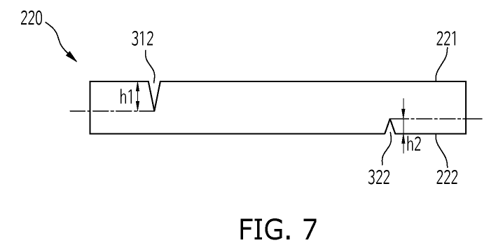

Referring to FIG. 7, the vent portions 312 and 322 may include a first vent portion 312 and a second vent portion 322. The first vent portion 312 may be formed in an outer surface 221 of the cover plate 220. The second vent portion 322 may be formed in an inner surface 222 of the cover plate 220. The outer surface may refer to a surface exposed to the outside of the case of the second battery, and the inner surface may refer to a surface facing the electrode assembly in the case of the second battery. In some embodiments, depths of the first vent portion 312 and the second vent portion 322 may be different. A depth h1 of the first vent portion 312 may be greater than a depth h2 of the second vent portion 322. In some embodiments, the depth h1 of the first vent portion 312 and the depth h2 of the second vent portion 322 may be the same.

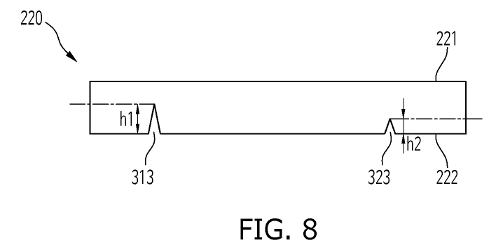

Referring to FIG. 8, the vent portions 313 and 323 may include a first vent portion 313 and a second vent portion 323. The first vent portion 313 and the second vent portion 323 may be formed in the inner surface 222 of the cover plate 220. In some embodiments, the depths of the first vent portion 313 and the second vent portion 323 may be different. A depth h1 of the first vent portion 313 may be greater than a depth h2 of the second vent portion 323. In some embodiments, the depth h1 of the first vent portion 313 and the depth h2 of the second vent portion 323 may be the same.

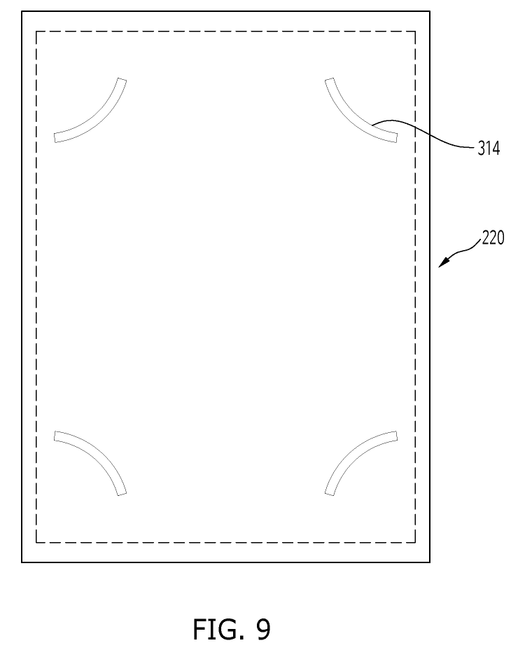

FIGS. 9-12 are diagrams illustrating various geometries of a vent portion according to some embodiments of the present disclosure.

Vent portions of various geometries according to some embodiments of the present disclosure may be formed in the cover plate.

As shown in FIG. 9, the vent portion 314 may include a vent line having a geometry of a curved line. The vent portion 314 may be a vent line having an arced geometry, but the vent portion 314 is not limited thereto. In FIG. 9, a respective vent portion 314 is shown at each corner of the cover plate 220. However, the present disclosure is not limited thereto, and one or more vent portions 314 may be formed.

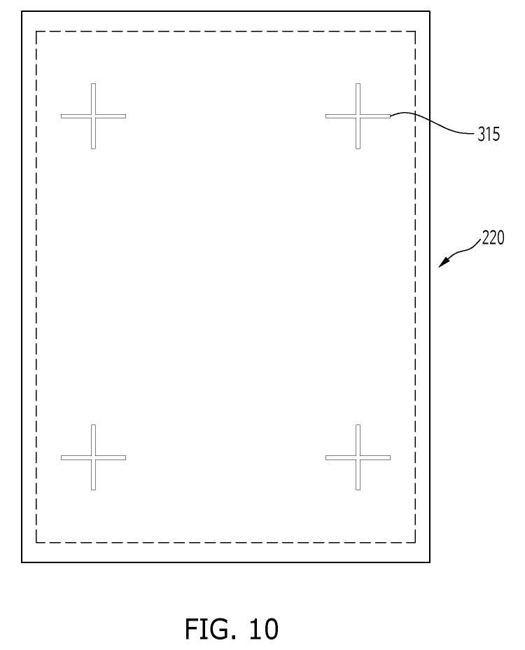

As shown in FIG. 10, the vent portion 315 may include two vent lines intersecting each other. The vent portion 315 may include two vent lines intersecting at a right angle, but the vent portion 315 is not limited thereto. In FIG. 10, a respective vent portion 315 is shown at each corner of the cover plate 220. However, the present disclosure is not limited thereto, and one or more vent portions 315 may be formed.

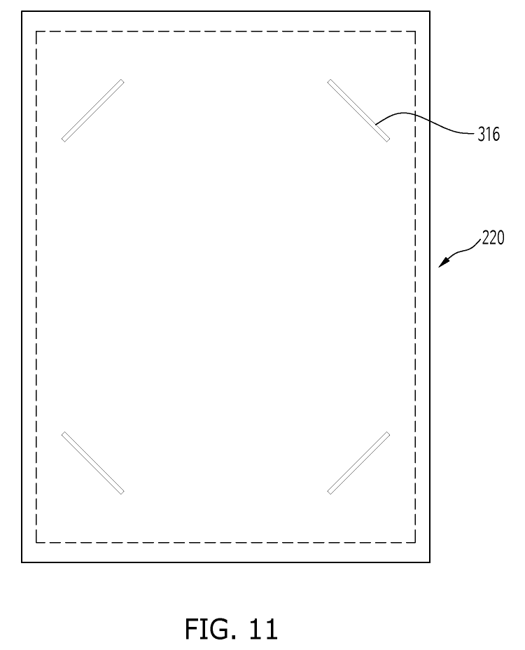

As shown in FIG. 11, the vent portion 316 may include a vent line in a geometry of a straight line. The vent portion 316 may include straight vent lines in various directions such as horizontal, vertical, and diagonal directions. In FIG. 11, a respective vent portion 316 is shown at each corner of the cover plate 220, but the present disclosure is not limited thereto, as one or more vent portions 316 may be formed.

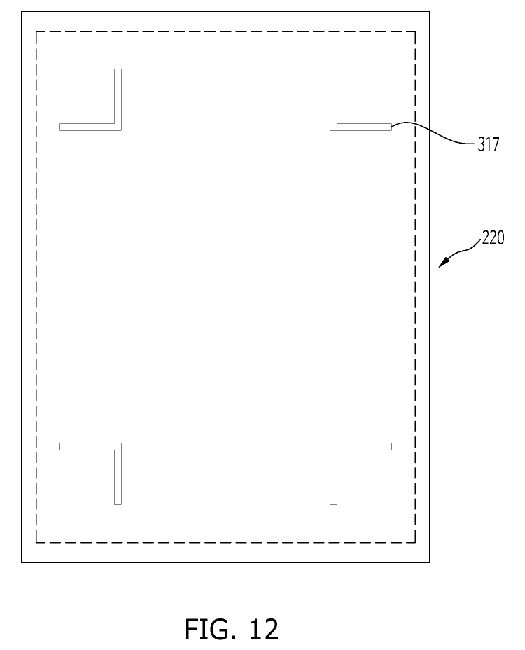

As shown in FIG. 12, the vent portion 317 may include vent lines having intersecting “L” geometries, but the vent portion 317 is not limited thereto. Further, in FIG. 12, a respective vent portion 317 is shown at each corner of the cover plate 220, but the present disclosure is not limited thereto, as one or more vent portions 317 may be formed.

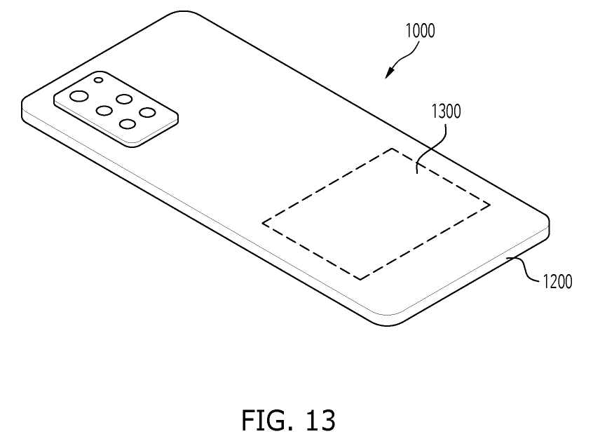

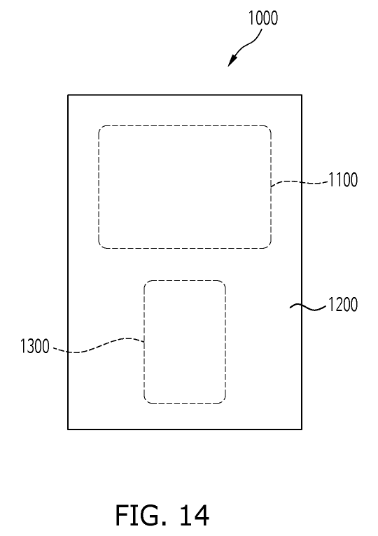

FIGS. 13 and 14 are diagrams illustrating an electronic device including a secondary battery according to some embodiments of the present disclosure.

Referring to FIGS. 13 and 14, an electronic device 1000 according to some embodiments of the present disclosure may include an operator 1100, a housing 1200, and a secondary battery 1300. The operator may be configured to perform a predetermined operation. The housing 1200 may accommodate the operator 1100 and the secondary battery 1300, such that a position of each of the operator 1100 and the secondary battery 1300 are fixed. The secondary battery 1300 may supply power to the operator 1100.

The electronic device 1000 including the secondary battery 1300 may be a smartphone. However, the electronic device 1000 is not limited thereto and may be used in various devices that use electric energy stored in the secondary battery 1300, and the electronic device 1000 may require a protection circuit.

The operator 1100 may include various hardware components driven by electric energy supplied from the secondary battery 1300. The operator 1100 may include an application processor (AP) and/or a central processing unit (CPU) of a portable electronic device.

A printed circuit board (not shown) including signal transmission wirings may be disposed inside the housing 1200, and the operator 1100 may be mounted on the printed circuit board and may be electrically connected to other components of the electronic device 1000.

The housing 1200 may accommodate the operator 1100 and the secondary battery 1300, and the housing 1200 may define an external appearance of the electronic device 1000. The housing 1200 may support the operator 1100 and the secondary battery 1300 and may have various structures, as long as the housing 1200 can protect the operator 1100 and the secondary battery 1300 from external impacts.

The secondary battery 1300 may be fixed inside the housing 1200 and may stably supply power to the operator 1100. The secondary battery 1300 may be disposed in a power supply region inside the housing 1200 and may be connected to terminals of the printed circuit board. Accordingly, the operator 1100 may be driven using electric energy stored in the secondary battery 1300.

The secondary battery 1300 may include an electrode assembly including a first electrode, a second electrode, and a separator, and a case accommodating the electrode assembly. The case may include a body part having an open side and configured to accommodate the electrode assembly, a cover plate configured to cover one open side of the body part and to seal the electrode assembly, and a flange portion extending from the body part and configured to contact the cover plate. The cover plate may include a vent portion that opens a part of the electrode assembly.

The vent portion may be configured as at least one vent portion on an inner surface or an outer surface of the cover plate. The inner surface and the outer surface of the cover plate are respectively an inner surface and outer surface of the case.

The case may be formed of stainless steel (SUS). The case may be formed of a conductive metal such as aluminum, aluminum alloy, or nickel-plated steel. In some embodiments, a thickness of the case may be from about 0.05 mm to about 0.1 mm, but the thickness of the case is not limited thereto.

The secondary battery 1300 has substantially the same configuration as the secondary battery 10 described with reference to FIGS. 1-12, and, thus, a detailed description of the configuration of the secondary battery 1300 is omitted.

Although the present disclosure has been described above with respect to some embodiments thereof, the present disclosure is not limited to the above-described embodiments. Various modifications and variations can be made to the above-described embodiments by those skilled in the art.

What is claimed is:

1. A secondary battery comprising:
an electrode assembly comprising a first electrode, a second electrode, and a separator; and
a case accommodating the electrode assembly, the case comprising:
a body part having an open side and accommodating the electrode assembly; and
a cover plate covering the open side of the body part and comprising a vent portion.

2. The secondary battery as claimed in claim 1, wherein the vent portion is at a corner portion of the cover plate.

3. The secondary battery as claimed in claim 2, wherein the cover plate comprises:
a first edge;
a second edge spaced apart from the first edge in a first direction;
a third edge spaced apart from the second edge in a second direction perpendicular to the first direction; and
a fourth edge spaced apart from the first edge in the second direction, and
wherein the corner portion is a rectangular region formed by sides of the cover plate at a 1/4 point on a diagonal line extending from the first edge to the third edge.

4. The secondary battery as claimed in claim 1, wherein a depth of the vent portion is from about 30% to about 80% of a thickness of the cover plate.

5. The secondary battery as claimed in claim 4, wherein the depth of the vent portion varies depending on a location of the vent portion in the cover plate.

6. The secondary battery as claimed in claim 1, wherein the vent portion is in an outer surface of the cover plate.

7. The secondary battery as claimed in claim 1, wherein the vent portion is in an inner surface of the cover plate.

8. The secondary battery as claimed in claim 1, wherein the vent portion is a first vent portion, and
wherein the cover plate further comprises a second vent portion.

9. The secondary battery as claimed in claim 8, wherein the first vent portion is in an inner surface of the cover plate, and
wherein the second vent portion is in an outer surface of the cover plate.

10. The secondary battery as claimed in claim 8, wherein a depth of the first vent portion is substantially equal to a depth of the second vent portion.

11. The secondary battery as claimed in claim 8, wherein a depth of the first vent portion is different from a depth of the second vent portion.

12. The secondary battery as claimed in claim 1, wherein a geometry of the vent portion is a curved line, a single straight line, a plurality of intersecting straight lines, or a circular geometry.

13. The secondary battery as claimed in claim 1, wherein the case comprises stainless steel.

14. The secondary battery as claimed in claim 1, further comprising a flange portion,
wherein the cover plate and the flange portion are joined together to seal the case.

15. An electronic device comprising:
an operator configured to perform a predetermined operation;
a secondary battery supplying power to the operator, the secondary battery comprising:
an electrode assembly comprising a first electrode, a second electrode, and a separator; and
a case accommodating the electrode assembly, the case comprising:
a body part having an open side and accommodating the electrode assembly; and
a cover plate covering the open side of the body part and comprising a vent portion; and
a housing accommodating the operator and the secondary battery and fixing a position of the operator and a position of the secondary battery.

16. A method of forming a vent portion in the case of electronic device as claimed in claim 15, the method comprising etching the vent portion into the cover plate.

17. The electronic device as claimed in claim 15, wherein the vent portion is at a corner portion of the cover plate.

18. The electronic device as claimed in claim 15, wherein the vent portion is in an inner surface or in an outer surface of the cover plate.

19. The electronic device as claimed in claim 15, wherein the vent portion is a first vent portion, and
wherein the cover plate further comprises a second vent portion.

20. The electronic device as claimed in claim 19, wherein the first vent portion is in an inner surface of the cover plate, and
wherein the second vent portion is in an outer surface of the cover plate.
